(19) United States
(12) Patent Application Publication
(10) Pub. No.: US 2026/0315203 A1
(43) Pub. Date: Oct. 15, 2026

(54) TUBULAR HANDLING TOOL WITH PENETRABLE CAP FOR PHYSIOLOGICAL ASSESSMENT OF LABORATORY ANIMALS

(71) Applicant: Mouse Specifics, Inc., Framingham, MA (US)

(72) Inventor: Thomas G. Hampton, Framingham, MA (US)

(21) Appl. No.: 19/638,903

(22) Filed: Apr. 3, 2026

Related U.S. Application Data
(60) Provisional application No. 63/786,143, filed on Apr. 9, 2025.

(51) Int. Cl. A61D 3/00

(52) U.S. Cl. CPC A61D 3/00

(57) ABSTRACT

A tubular handling tool for laboratory animals comprises a cylindrical body having a proximal end and a distal end, the cylindrical body defining an interior space configured to accommodate a small laboratory animal. A fixed cap is permanently adhered to the distal end of the cylindrical body, the fixed cap being made of a material penetrable by chewing or gnawing by the laboratory animal inside the interior space. A starter hole is disposed in the fixed cap, the starter hole configured to provide a starting point from which the laboratory animal may chew or gnaw to create an escape opening through the fixed cap. The tubular handling tool may further comprise a removable cap configured to be attached to the proximal end and conductive strips disposed along an interior floor for ECG recording.

### CROSS-REFERENCE TO RELATED APPLICATION(S)

This application claims priority to, and the benefit of, co-pending U.S. Provisional Application No. 63/786,143, filed Apr. 9, 2025, for all subject matter common to both applications. The disclosure of said provisional application is hereby incorporated by reference in its entirety.

### FIELD OF THE INVENTION

The present disclosure relates to tools for handling laboratory animals, and more particularly to a tubular handling tool configured with a fixed penetrable cap for measuring physiological characteristics, including neck, shoulder, jaw, mouth, brain, and heart function in small laboratory animals such as mice, rats, hamsters, and guinea pigs.

### BACKGROUND

Laboratory animals, particularly small rodents such as mice, rats, hamsters, and guinea pigs, are extensively used in biomedical research across numerous fields, including obesity, diabetes, cardiovascular disease, neurological disorders, musculoskeletal conditions, and aging studies. Tens of millions of laboratory mice are studied each year, typically housed in standard shoebox cages, and routinely handled for various experimental procedures.

While advances continue to be made in collecting physiological data from animals in their home cages using sensors, cameras, and automated monitoring systems, it remains common practice to remove animals from their cages for measurements, examinations, or the administration of therapeutic agents. For example, in obesity studies, an animal might be periodically retrieved and placed on a scale to monitor weight changes. Similarly, in oncology research, animals may be retrieved multiple times daily for drug administration and periodic tumor measurements. Veterinary staff, animal technicians, and husbandry personnel also routinely handle animals for intimate examination, fluid extraction, and general care.

There is growing recognition in the research community that retrieving laboratory animals using handling tools rather than direct human hand contact may be preferable for animal welfare and contentment. Researchers and laboratory animal personnel increasingly use small tubes or tunnels, typically cylindrical and made of cardboard or plastic, to retrieve animals from their cages. These tubes generally have dimensions approximating the size of an adult mouse, are easily grasped by a human hand, and fit readily inside typical laboratory cages. With minimal practice, personnel can scoop up a mouse with such a tube, transport the animal to a procedure station, and subsequently return the animal to its cage.

Existing animal handling tubes and restraint devices have been developed for various purposes, including facilitating access to specific body parts for physiological and pharmacological studies, enabling injections, and allowing monitoring of certain physiological parameters. However, conventional handling tools and restraint apparatuses may not fully capitalize on the opportunity to gather meaningful physiological and behavioral data during routine handling.

The assessment of upper-body function, including neck mobility, shoulder strength, jaw function, oral health, and neurological status, poses challenges in small laboratory animals. Traditional methods for evaluating these parameters may require specialized equipment, trained personnel, or procedures that induce stress in the animals. Similarly, cardiac monitoring in freely behaving animals within their home cage environment presents technical challenges related to electrode placement and signal acquisition.

Accordingly, there remains an opportunity to develop improved tools and methods that facilitate routine handling of laboratory animals while simultaneously enabling assessment of the animals' physiological attributes and behavioral characteristics during handling.

### SUMMARY

This summary is provided to introduce a selection of concepts in simplified form, which are further described below in the detailed description. This summary is not intended to identify key features or essential features of the claimed subject matter, nor is it intended to be used as an aid in determining the scope of the claimed subject matter.

According to an aspect of the present disclosure, a tubular handling tool for laboratory animals is provided. The tubular handling tool includes a cylindrical body having a proximal end and a distal end. The cylindrical body defines an interior space configured to accommodate a small laboratory animal. The tubular handling tool includes a fixed cap permanently adhered to the distal end of the cylindrical body. The fixed cap is made of a material penetrable by chewing or gnawing by the laboratory animal inside the interior space. The tubular handling tool includes a starter hole disposed in the fixed cap. The starter hole is configured to provide a starting point from which the laboratory animal may chew or gnaw to create an escape opening through the fixed cap.

According to other aspects of the present disclosure, the tubular handling tool may include one or more of the following features. The fixed cap may be made of kraft cardstock. The fixed cap may be permanently adhered to the distal end of the cylindrical body with a non-toxic adhesive. The non-toxic adhesive may be super glue. The starter hole may have a diameter in a range from 1/32 inch to ⅛ inch. The starter hole may be configured to allow air and light to enter the interior space. The tubular handling tool may further include a removable cap configured to be attached to the proximal end of the cylindrical body to retain the laboratory animal inside the interior space. The removable cap may require human force to remove and may be configured so that the laboratory animal inside the interior space does not have sufficient strength to remove it from the inside. The removable cap may be made from a hard and smooth material that cannot be penetrated by teeth or claws of the laboratory animal inside. The cylindrical body may have a diameter in a range from 1.5 inches to 2.5 inches, a wall thickness in a range from 0.125 inches to 0.25 inches, and a length in a range from 3 inches to 5 inches. The fixed cap may include printed markings configured to aid in quantifying a rate and extent of chewing or gnawing by the laboratory animal.

According to another aspect of the present disclosure, a method for assessing physiological characteristics of a laboratory animal is provided. The method includes providing a tubular tool having a cylindrical body with a proximal end and a distal end, wherein the distal end includes a fixed cap made of a penetrable material. The method includes placing the laboratory animal inside the cylindrical body through the proximal end. The method includes securing the proximal end to retain the laboratory animal inside the tubular tool. The method includes observing an escape hole created when the laboratory animal chews or gnaws through the fixed cap. The method includes assessing a physiological characteristic of the laboratory animal based on at least one of a size, a shape, a rate of formation, and a pattern of the escape hole.

According to other aspects of the present disclosure, the method may include one or more of the following features. The physiological characteristic may be selected from the group consisting of neck mobility, shoulder function, jaw strength, oral health, neurological status, anxiety level, aggression level, and pain laterality. The method may further include a step of recording the escape hole with a camera positioned within view of the fixed cap. The method may further include a step of using image processing techniques to quantify at least one of a speed and an extent of gnawing when escape occurs. The fixed cap may include printed markings, and the method may further include a step of using the printed markings to quantify a rate and an extent of chewing or gnawing by the laboratory animal. The method may further include a step of treating the fixed cap with an agent configured to affect a speed of chewing by the laboratory animal. The agent may be selected from the group consisting of a sugar-based sweetener configured to increase the speed of chewing and capsaicin configured to decrease the speed of chewing. The method may further include a step of diagnosing a lateralized condition based on an asymmetry of the escape hole pattern, wherein the asymmetry indicates pain or injury on a side of the laboratory animal opposite to a direction of the asymmetry. The method may further include a step of detecting a temperature inside the tubular tool with a temperature probe, wherein a decrease in temperature toward ambient temperature indicates that the laboratory animal has exited the tubular tool through the escape hole.

According to another aspect of the present disclosure, a system for handling and monitoring laboratory animals is provided. The system includes a tubular tool. The tubular tool includes a cylindrical body having an interior space configured to accommodate a laboratory animal. The tubular tool includes a fixed cap permanently adhered to a distal end of the cylindrical body. The fixed cap is made of a material penetrable by the laboratory animal. The tubular tool includes two conductive strips disposed along an interior floor of the cylindrical body. The two conductive strips are separated by a neutral floor region. The system includes ECG recording instrumentation electrically connected to the two conductive strips. The ECG recording instrumentation is configured to detect and record electrocardiogram signals from the laboratory animal standing inside the tubular tool with paws contacting the two conductive strips.

According to other aspects of the present disclosure, the system may include one or more of the following features. The fixed cap may include a starter hole configured to provide a starting point from which the laboratory animal may chew or gnaw to create an escape opening through the fixed cap. The tubular tool may be configured to be positioned inside an animal cage, and the ECG recording instrumentation may be configured to detect and record electrocardiogram signals when the laboratory animal voluntarily enters the tubular tool. The system may further include a camera positioned within view of the fixed cap. The camera may be configured to monitor and record progress of the laboratory animal chewing or gnawing through the fixed cap. The system may further include image processing means configured to quantify at least one of a speed and an extent of gnawing when escape occurs.

The foregoing general description of the illustrative embodiments and the following detailed description thereof are merely exemplary aspects of the teachings of this disclosure and are not restrictive.

### BRIEF DESCRIPTION OF THE FIGURES

These and other characteristics of the present invention will be more fully understood by reference to the following detailed description in conjunction with the attached drawings, in which:

FIG. 1 is a perspective view of a tubular tool for handling laboratory animals according to an embodiment of the present disclosure;

FIG. 2 is an illustration depicting retrieval of a laboratory animal from a cage using the tubular tool according to an embodiment of the present disclosure;

FIG. 3 is a side view of the tubular tool with a laboratory animal positioned inside according to an embodiment of the present disclosure;

FIG. 4 is a sequential illustration showing progressive stages of a laboratory animal chewing through a fixed cap of the tubular tool to effect escape according to an embodiment of the present disclosure;

FIG. 5 is an end view of fixed caps showing measurement markings for quantifying chewing progress, with the left cap showing an initial state and the right cap showing a state after chewing has occurred, according to an embodiment of the present disclosure;

FIG. 6 is an illustration showing various escape hole patterns observable in the fixed cap and their correlation with physiological and behavioral conditions according to an embodiment of the present disclosure;

FIG. 7 is a photograph showing the tubular tool in practice, with a left panel depicting a baseline state with a mouse inside and a right panel depicting the fixed cap after chewing has occurred, according to an embodiment of the present disclosure;

FIG. 8 is a schematic illustration of a tubular tool configured with conductive strips for ECG recording, showing a laboratory animal inside the tool and a corresponding ECG waveform output, according to an embodiment of the present disclosure;

FIG. 9 is an illustration of a home cage monitoring configuration with the tubular tool positioned inside an animal enclosure and connected to external ECG recording instrumentation according to an embodiment of the present disclosure; and

FIG. 10 is an example flow diagram for a method of assessing physiological characteristics of a laboratory animal.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a tubular handling tool configured for retrieving and handling small laboratory animals such as mice, rats, hamsters, guinea pigs, and sugar gliders. The tubular handling tool may comprise a cylindrical body having a proximal end and a distal end, with the cylindrical body defining an interior space configured to accommodate a small laboratory animal. A fixed cap may be permanently adhered to the distal end of the cylindrical body, with the fixed cap being made of a material that is penetrable by chewing or gnawing by a laboratory animal positioned inside the interior space. The proximal end of the cylindrical body may remain open to permit entry of the laboratory animal, or a removable cap may be attached to the proximal end to retain the laboratory animal inside the interior space during handling procedures.

The tubular handling tool addresses the growing preference in laboratory animal research for retrieving animals using tools rather than direct hand contact, which may improve animal welfare and reduce stress responses in the animals being handled. The cylindrical body of the tubular handling tool may have dimensions configured to approximate the size of an adult mouse or other small laboratory animal, allowing the tool to be easily grasped by a human hand and to fit inside a typical laboratory cage. The wall thickness of the cylindrical body may be configured to mitigate the possibility of the laboratory animal chewing or gnawing through the wall of the cylindrical body.

The fixed cap adhered to the distal end of the cylindrical body may include a starter hole configured to provide a starting point from which the laboratory animal may chew or gnaw to create an escape opening through the fixed cap. The starter hole may also permit entry of air and light into the interior space of the tubular handling tool. As the laboratory animal chews or gnaws through the fixed cap material to enlarge the starter hole and create an escape opening, the size, shape, rate of formation, and pattern of the resulting escape hole may be observed and assessed to provide information regarding physiological characteristics of the laboratory animal. Such physiological characteristics may include neck mobility, shoulder function, jaw strength, oral health, neurological status, anxiety level, aggression level, and pain laterality.

The tubular handling tool may further incorporate conductive strips disposed along an interior floor of the cylindrical body to enable passive detection and recording of electrocardiogram signals from a laboratory animal standing inside the tubular handling tool. The tubular handling tool thus provides a dual-function apparatus that facilitates both humane handling of laboratory animals and the collection of physiological data during handling procedures or during voluntary entry into the tool when it is positioned inside an animal cage.

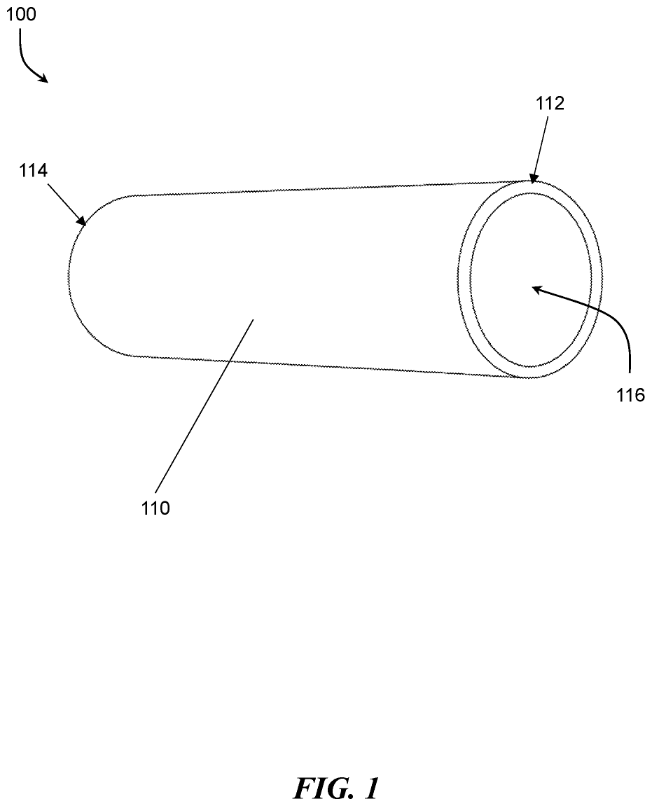

Referring to FIG. 1, a tubular handling tool 100 for laboratory animals comprises a cylindrical body 110 having a proximal end 112 and a distal end 114. The cylindrical body 110 defines an interior space 116 configured to accommodate a small laboratory animal such as a mouse, rat, hamster, guinea pig, or sugar glider. The cylindrical body 110 may be made of cardboard material, and the tubular handling tool 100 may be disposable after use.

With continued reference to FIG. 1, the cylindrical body 110 may have a diameter in a range from 1.5 inches to 2.5 inches. In some cases, the diameter may be approximately 2 inches, which approximates the size of an adult mouse and allows the tubular handling tool 100 to be easily grasped by a human hand. The cylindrical body 110 may have a wall thickness in a range from 0.125 inches to 0.25 inches. A wall thickness greater than 0.125 inches mitigates the possibility of the laboratory animal inside the interior space 116 chewing or gnawing through the wall of the cylindrical body 110. The cylindrical body 110 may have a length in a range from 3 inches to 5 inches. In some cases, the length may be approximately 3.9 inches, which allows the tubular handling tool 100 to fit inside a typical laboratory cage while providing sufficient space to accommodate the laboratory animal within the interior space 116.

As further shown in FIG. 1, the proximal end 112 of the cylindrical body 110 may be configured as an open end to permit entry and exit of the laboratory animal, while the distal end 114 may be configured to receive a fixed cap. The dimensions of the tubular handling tool 100, including the diameter, wall thickness, and length of the cylindrical body 110, may be adjusted according to the size of the subject to be positioned inside the interior space 116. For example, larger dimensions may be selected for rats or guinea pigs, while smaller dimensions may be selected for mice or sugar gliders.

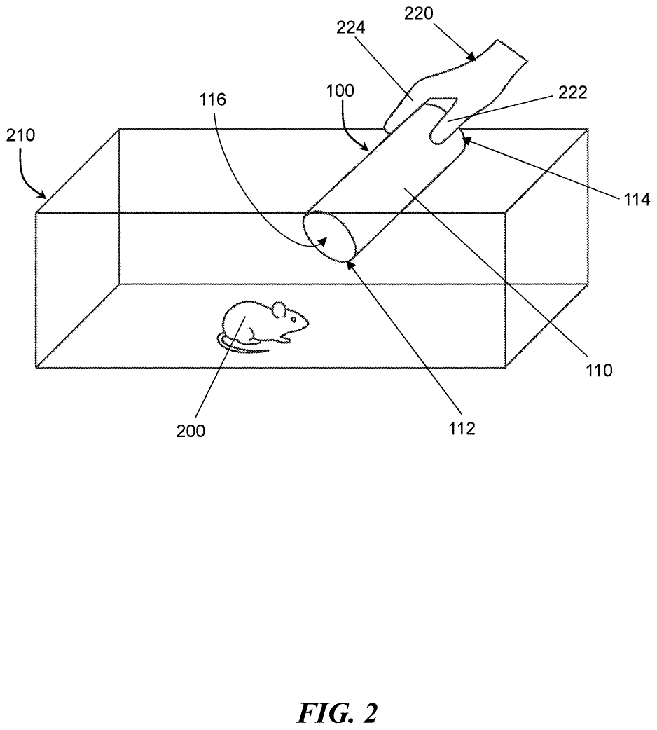

Referring to FIG. 2, a method for assessing physiological characteristics of a laboratory animal may include providing a tubular tool 100 having a cylindrical body 110 with a proximal end 112 and a distal end 114, as described above with respect to the tubular handling tool 100. FIG. 2 depicts a perspective view of the tubular handling tool 100 being used to retrieve a laboratory animal 200 from an enclosure 210. A human hand 220 grasps the tubular handling tool 100 near an upper portion of the cylindrical body 110, with the thumb 222 positioned on one side and fingers 224 wrapped around an opposite side of the cylindrical body 110. The tubular handling tool 100 is oriented at a diagonal angle, with the open proximal end 112 directed downward toward the interior space 116 of the enclosure and toward the laboratory animal 200 positioned inside the enclosure 210.

With continued reference to FIG. 2, the method may include placing the laboratory animal 200 inside the cylindrical body 110 through the proximal end 112. The human hand 220 directs the tubular handling tool 100 toward the laboratory animal 200 and scoops up the animal 200 through the open proximal end 112. The laboratory animal 200 enters the interior space 116 of the cylindrical body 110 as the tubular handling tool 100 is moved over and around the animal 200. A fixed cap at the distal end 114 prevents the laboratory animal 200 from exiting through the distal end 114 during the retrieval procedure, thereby directing the animal to remain within the interior space 116.

The tubular handling tool 100 may be used for retrieving small animals, including sugar gliders, mice, rats, hamsters, and guinea pigs. The retrieval procedure using the tubular handling tool 100 may reduce stress responses in the laboratory animal 200 compared to direct hand contact, as the animal 200 enters an enclosed cylindrical interior space 116 that approximates a natural preference for enclosed environments. With even small practice, an operator may easily scoop up a laboratory animal with the tubular handling tool 100, bring the animal to a station for a scheduled procedure, and subsequently return the animal to the cage. The dimensions of the tubular handling tool 100 may be selected according to the species and size of the laboratory animal to be retrieved, with larger dimensions for rats or guinea pigs and smaller dimensions for mice or sugar gliders.

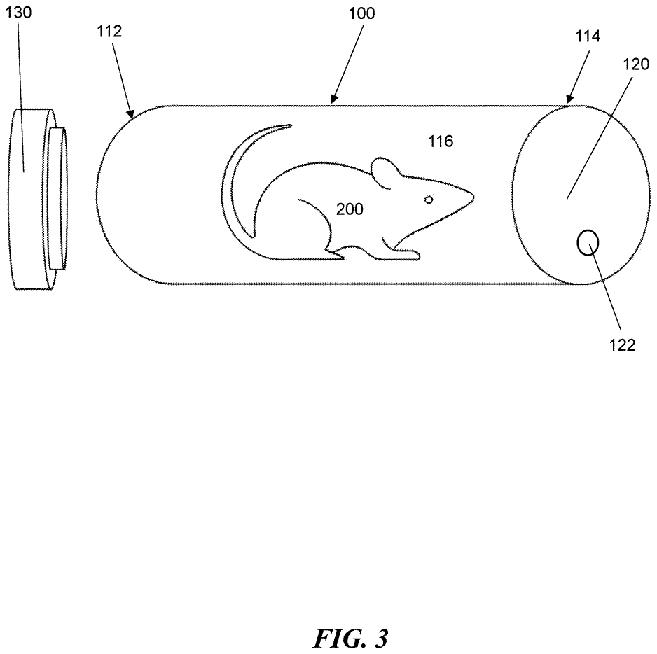

Referring to FIG. 3, the tubular handling tool 100 includes a fixed cap 120 permanently adhered to the distal end 114 of the cylindrical body 110. The fixed cap 120 is made of a material penetrable by chewing or gnawing by the laboratory animal 200 inside the interior space 116. In some cases, the fixed cap 120 may be made of kraft cardstock or a similar material that the laboratory animal 200 can chew or penetrate to effect escape from the tubular handling tool 100.

With continued reference to FIG. 3, the fixed cap 120 may be permanently adhered to the distal end 114 of the cylindrical body 110 with a non-toxic adhesive. In some cases, the non-toxic adhesive may be super glue, which becomes non-toxic when dried and provides a permanent bond between the fixed cap 120 and the cylindrical body 110. The permanent adhesion of the fixed cap 120 to the distal end 114 ensures that the fixed cap 120 remains in place during handling procedures and cannot be dislodged by the laboratory animal 200 inside the interior space 116.

As further shown in FIG. 3, a starter hole 122 may be disposed in the fixed cap 120. The starter hole 122 may have a diameter in a range from 1/32 inch to ⅛ inch. The starter hole 122 is configured to provide a starting point from which the laboratory animal 200 may chew or gnaw to create an escape opening through the fixed cap 120. The starter hole 122 provides a natural location from which the laboratory animal 200 may commence enlarging the opening by chewing or gnawing the penetrable material of the fixed cap 120.

The starter hole 122 is also configured to permit air and light to enter the interior space 116 of the tubular handling tool 100. The entry of air through the starter hole 122 provides ventilation for the laboratory animal 200 positioned inside the interior space 116, while the entry of light through the starter hole 122 may make the distal end 114 a more attractive end through which the laboratory animal may choose to escape. The combination of air, light, and a starting point for chewing encourages the laboratory animal to direct escape efforts toward the fixed cap 120 rather than toward a removable cap 130 at the proximal end 112.

In an alternative configuration, the fixed cap 120 may be complete without a starter hole 122. In such cases, the fixed cap 120 made of a penetrable material, such as kraft cardstock, still permits the laboratory animal to chew or gnaw through the material to create an escape opening, though the laboratory animal initiates the opening without a pre-formed starting point 122. The complete fixed cap 120 without a starter hole 122 may be selected for applications where the operator desires to assess the ability of the laboratory animal to initiate an escape opening, in addition to enlarging an existing opening.

The tubular handling tool 100 may further comprise a removable cap 130 configured to be attached to the proximal end 112 of the cylindrical body 110, thereby retaining the laboratory animal within the interior space 116. As described previously, the proximal end 112 may be configured as an open end to permit entry of the laboratory animal 200 during retrieval procedures. Once the laboratory animal 200 has entered the interior space 116 through the proximal end 112, the removable cap 130 may be attached to the proximal end 112 to secure the proximal end 112 and retain the laboratory animal 200 inside the tubular handling tool 100 during handling, transport, or assessment procedures.

The removable cap 130 requires human force to remove and is configured such that the laboratory animal 200 inside the interior space 116 does not have sufficient strength to remove the removable cap 130 from inside. The removable cap 130 may be configured to engage with the proximal end 112 of the cylindrical body 110 through a friction fit, press fit, or other engagement mechanism that provides sufficient retention force to prevent the laboratory animal 200 from dislodging the removable cap 130 by pushing against the removable cap 130 from within the interior space 116. The retention force of the removable cap 130 may be selected to exceed the pushing force that the laboratory animal 200 can exert while remaining within a range that permits an operator to remove the removable cap 130 by hand without requiring tools.

The removable cap 130 may be made from a hard and smooth material that cannot be penetrated by teeth or claws of the laboratory animal 200 inside. The hard material of the removable cap 130 resists chewing or gnawing by the laboratory animal, while the smooth surface of the removable cap 130 prevents the laboratory animal 200 from gaining purchase with teeth or claws to initiate penetration of the material. The removable cap 130 made from a hard and smooth material directs the escape efforts of the laboratory animal 200 toward the fixed cap 120 at the distal end 114, which is made of a penetrable material as described previously.

In an alternative configuration, the removable cap 130 may be made from a soft material that the laboratory animal 200 inside can chew or penetrate to effect escape. The soft, removable cap permits the laboratory animal 200 to choose either or both ends of the tubular handling tool 100 from which to escape. When both the fixed cap 120 at the distal end 114 and the soft removable cap 130 at the proximal end 112 are made of penetrable materials, the laboratory animal 200 may direct chewing or gnawing efforts toward either end or may alternate between ends during escape attempts. The selection between a hard removable cap and a soft removable cap may depend on the assessment objectives of the operator, with the hard removable cap directing escape behavior toward the fixed cap 120 and the soft removable cap permitting observation of the laboratory animal's preference for escape direction.

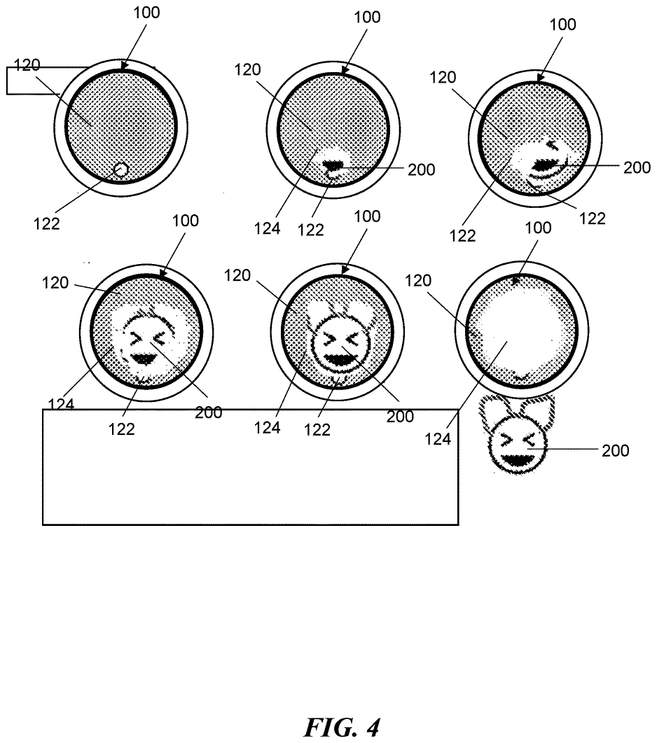

Referring to FIG. 4, the progressive stages of a laboratory animal chewing through the fixed cap 120 to effect escape are illustrated in a sequential arrangement proceeding from left to right across two rows. The sequence depicts how the laboratory animal begins at the starter hole 122 disposed in the fixed cap 120 and progressively enlarges the opening by chewing or gnawing the penetrable material of the fixed cap 120 until an escape hole 124 of sufficient size is created to permit the laboratory animal to exit the tubular handling tool 100.

With continued reference to FIG. 4, the sequence shows an initial state where the laboratory animal 200 is positioned within the interior space 116 of the tubular handling tool 100 with the fixed cap 120 intact except for the starter hole 122. The laboratory animal 200 may orient toward the fixed cap 120, attracted by the air and light entering through the starter hole 122. The laboratory animal 200 may then begin chewing or gnawing at the edges of the starter hole 122, using teeth to remove material from the fixed cap 120 and enlarge the opening.

As further shown in FIG. 4, the escape hole 124 progressively increases in size as the laboratory animal 200 continues chewing or gnawing the penetrable material of the fixed cap 120. The sequence illustrates intermediate stages where the escape hole 124 has grown from the initial size of the starter hole 122 to larger openings with irregular or jagged edges characteristic of chewing activity. The laboratory animal 200 may continue enlarging the escape hole 124 until the opening is sufficiently large to permit the body of the laboratory animal 200 to pass through the fixed cap 120 and exit the tubular handling tool 100.

The method for assessing physiological characteristics of a laboratory animal 200 includes observing an escape hole 124 created by the laboratory animal 200 chewing or gnawing through the fixed cap 120. As described previously with respect to FIG. 3, the fixed cap 120 is made of a penetrable material, such as kraft cardstock, that permits the laboratory animal 200 to chew or gnaw through the material. The observation of the escape hole 124 may be performed visually by an operator, or the observation may be performed using a camera positioned within view of the fixed cap 120 to monitor and record the progress of the laboratory animal 200 chewing or gnawing through the fixed cap 120.

The method further includes assessing a physiological characteristic of the laboratory animal 200 based on at least one of a size, a shape, a rate of formation, and a pattern of the escape hole 124. The size of the escape hole 124 may indicate behavioral characteristics such as anxiety level or aggression level, where a larger escape hole 124 may be associated with anxiety and a smaller escape hole 124 may be associated with aggression or impulsivity. The shape of the escape hole 124 may indicate symmetry or asymmetry in the chewing pattern, which may correlate with lateralized conditions affecting one side of the laboratory animal 200. The rate of formation of the escape hole 124 may indicate jaw strength, oral health, or the presence of conditions affecting the neck, shoulder, or mouth that slow or accelerate chewing activity. The pattern of the escape hole 124 may indicate chewing-preference direction, which may correlate with pain laterality or injury location.

With continued reference to FIG. 4, the final stage of the sequence depicts the laboratory animal 200 having created an escape hole 124 of sufficient size and having exited through the fixed cap 120. The completed escape hole 124 remains in the fixed cap 120 and may be examined after the laboratory animal 200 has escaped to assess the physiological characteristics based on the final size, shape, and pattern of the escape hole 124. The assessment may provide diagnostic information regarding conditions such as rotator cuff injuries, neck tumors, oral pain, or neurological status based on the characteristics of the escape hole 124 created by the laboratory animal 200.

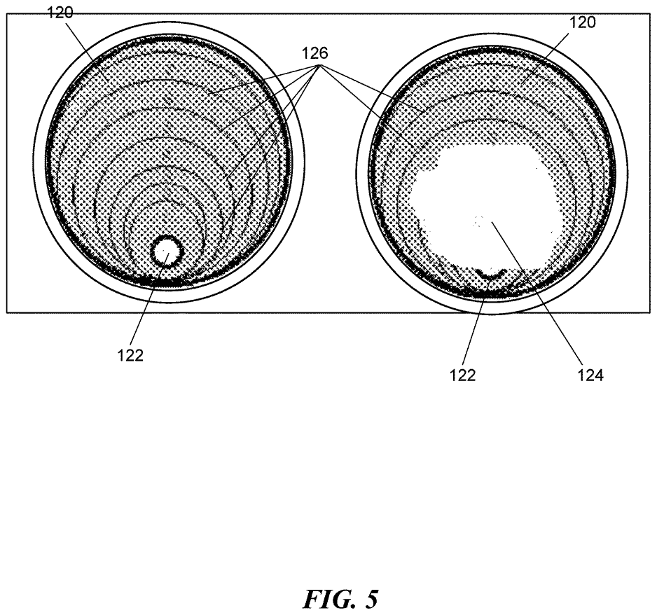

Referring to FIG. 5, the fixed cap 120 may include printed markings 126 configured to aid in quantifying a rate and extent of chewing or gnawing by the laboratory animal 200. The printed markings 126 may comprise circular markings arranged around the starter hole 122, with the circles providing reference gauges for measuring the size of the escape hole 124 as the laboratory animal 200 progressively enlarges the opening through chewing or gnawing activity.

With continued reference to FIG. 5, the circular markings of the printed markings 126 may be spaced at regular intervals radiating outward from the starter hole 122. Each circle may represent a known distance from the starter hole 122, allowing an operator to determine the radial extent of the escape hole 124 by observing which circles have been breached by the chewing activity of the laboratory animal. The printed markings 126 may also include numbers or other indicia associated with each circle to facilitate rapid identification of the extent of chewing progress.

As further shown in FIG. 5, the left panel depicts the fixed cap 120 in an initial state with the printed markings 126 intact and the starter hole 122 positioned along one of the inner circles. The right panel depicts the fixed cap 120 after the laboratory animal has chewed through a portion of the penetrable material, with an irregular escape hole 124 that has breached multiple circles of the printed markings 126. The contrast between the initial state and the post-chewing state illustrates how the printed markings 126 enable quantification of the extent of chewing by comparing the perimeter of the escape hole 124 to the reference gauges provided by the circular markings.

The method for assessing physiological characteristics of a laboratory animal may further comprise a step of using the printed markings 126 to quantify a rate and an extent of chewing or gnawing by the laboratory animal. The rate of chewing may be quantified by recording the time at which the escape hole 124 breaches successive circles of the printed markings 126, thereby providing a measure of how quickly the laboratory animal enlarges the opening over time. The extent of chewing may be quantified by measuring the final size of the escape hole 124 relative to the circular markings, with the outermost breached circle indicating the maximum radial extent of the escape hole 124.

The printed markings 126 may also facilitate assessment of the symmetry or asymmetry of the escape hole 124 pattern. By comparing the extent to which the escape hole 124 breaches the c circles in different directions around the circumference of the fixed cap 120, an operator may determine whether the laboratory animal chewed symmetrically in all directions or preferentially in a particular direction. Asymmetric chewing patterns, as indicated by uneven breach of the circular markings, may correlate with lateralized conditions such as neck tumors, rotator cuff injuries, or pain affecting one side of the laboratory animal 200, as previously described.

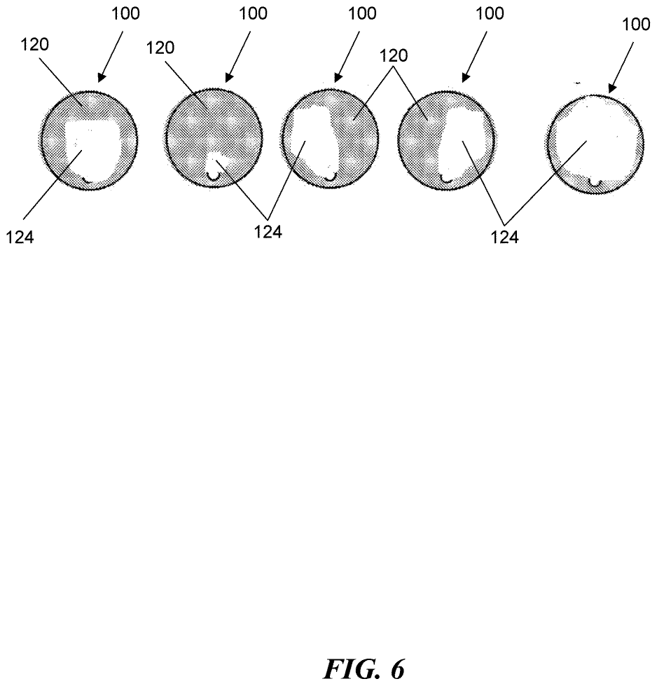

Referring to FIG. 6, a series of escape hole 124 patterns created by a laboratory animal 200 chewing through the fixed cap illustrates how the size, shape, and pattern of the evolving escape hole 124 may provide diagnostic information regarding the physiological and behavioral characteristics of the laboratory animal 200. The sequence depicts five types of escape hole 124 formation as the laboratory animal chews through the penetrable material to effect escape.

With continued reference to FIG. 6, the physiological characteristic assessed from the escape hole 124 pattern may be selected from the group consisting of neck mobility, shoulder function, jaw strength, oral health, neurological status, anxiety level, aggression level, and pain laterality. Each of these physiological characteristics may influence the manner in which the laboratory animal 200 chews or gnaws through the fixed cap 120, resulting in observable differences in the speed of escape, the size of the escape hole 124, and the symmetry or asymmetry of the escape hole 124 pattern.

The first example shown in the far left of the series depicts a “normal” escape hole 124. The size and location of the “normal” escape hole 124 may depend of the age, size, strain, and/or gender of the laboratory animal 200.

The second example from the left in the series depicts a slow or timid escape hole 124. This may indicate an anxious, sickly, or in pain laboratory animal 200. In other embodiments, it may be the result of the fixed cap 120 being made of a noxious or bad-tasting material. Alternatively, the escape hole 124 pattern may indicate oral pain by a slow escape speed. A laboratory animal 200 experiencing oral pain, such as from dental conditions or oral-maxillofacial injuries, may exhibit reduced chewing activity due to discomfort associated with the chewing motion. The resulting escape hole 124 may form more slowly than in a healthy or “normal” laboratory animal 200, with the rate of escape hole 124 formation providing an indicator of oral health status.

With continued reference to FIG. 6, the escape hole 124 pattern may indicate anxiety through a slow escape speed and a potentially large escape hole 124. A laboratory animal 200 exhibiting anxiety may hesitate before initiating escape attempts and may chew more cautiously, resulting in slower escape speed. However, an anxious laboratory animal 200 may continue chewing beyond the minimum opening size required for escape, resulting in a larger escape hole 124 than would be created by a non-anxious laboratory animal 200.

The third example from the left in the series depicts a right asymmetry escape hole 124. This may indicate pain on the left side of laboratory animal 200, directing the laboratory animal to chew mostly on the right side, away from the pain. The escape hole 124 pattern may indicate a neck tumor on the left side through slow escape speed and opening directed to the right. A laboratory animal 200 with a tumor affecting the left side of the neck may experience restricted neck mobility or pain when turning toward the affected side, resulting in slower overall chewing and a preference to direct chewing efforts toward the right side of the fixed cap. The resulting escape hole 124 may exhibit an asymmetric pattern, with the opening extending preferentially to the right, away from the side of the tumor.

The fourth example from the left in the series depicts a left asymmetry escape hole 124. This may indicate pain on the right side of the laboratory animal 200 directing the laboratory animal to chew mostly on the left side away from the pain. The escape hole 124 pattern may indicate a rotator cuff tear on the right side through slow escape speed and asymmetric opening pattern. A laboratory animal 200 with a rotator cuff injury affecting the right shoulder may exhibit reduced mobility and strength on the affected side, resulting in slower chewing activity and a tendency to direct chewing efforts away from the injured side. The resulting escape hole 124 may exhibit an asymmetric pattern, with the opening extending preferentially toward the left side of the fixed cap, opposite the side of the injury.

The fifth example on the far right in the series depicts an aggressive escape hole 124. This may indicate an energetic, hyperactive, or obese laboratory animal 200. In other embodiments, it may be the result of the fixed cap 120 being made of a favorable-tasting material. Alternatively, the escape hole 124 pattern may indicate aggression through a fast escape speed and a potentially small escape hole. A laboratory animal 200 exhibiting aggression or impulsivity may rapidly initiate escape attempts and chew vigorously, resulting in a fast escape speed. An aggressive or impulsive laboratory animal 200 may exit through the escape hole 124 as soon as the opening reaches a minimally sufficient size, resulting in a smaller escape hole 124 than would be created by a less aggressive laboratory animal 200.

The method for assessing physiological characteristics may further comprise a step of diagnosing a lateralized condition based on an asymmetry of the escape hole 124 pattern. As described previously, conditions affecting one side of laboratory animal 200, such as rotator cuff injuries or neck tumors, may result in asymmetric escape-hole patterns. The asymmetry indicates pain or injury on a side of the laboratory animal 200 opposite to a direction of the asymmetry. For example, an escape hole 124 pattern extending preferentially toward the right side of the fixed cap may indicate pain or injury on the left side of the laboratory animal 200, as the laboratory animal 200 directs chewing efforts away from the affected side to avoid discomfort or compensate for reduced mobility on the injured side.

An injury to the mouth or to the neck of the laboratory animal may affect the speed and pattern with which the laboratory animal 200 effects escape. Mouth injuries may reduce chewing speed due to pain associated with the chewing motion, while neck injuries may affect the direction and symmetry of the escape hole pattern due to restricted neck mobility or pain when turning toward the affected side. The combination of escape speed and escape hole 124 pattern may provide diagnostic information regarding the location and nature of injuries affecting the laboratory animal 200.

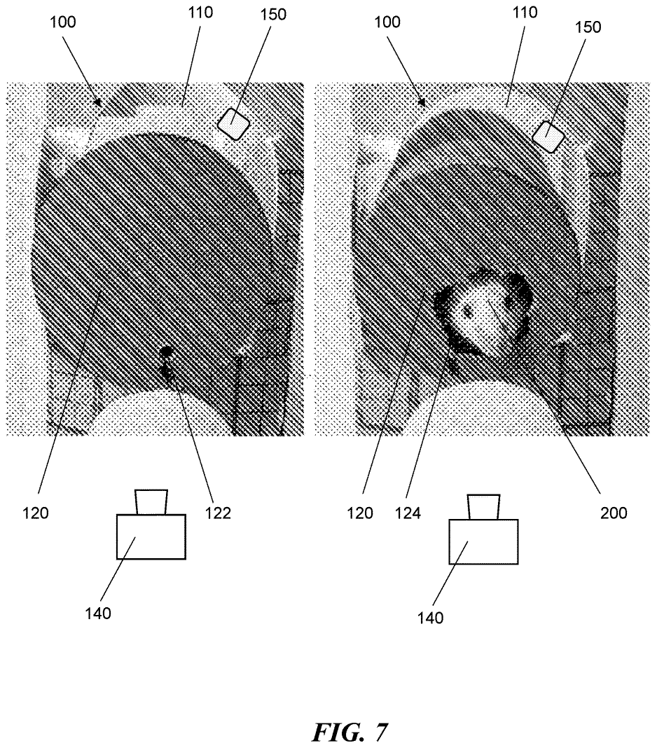

Referring to FIG. 7, the tubular handling tool 100 is shown in practical implementation with a laboratory animal 200 positioned inside the cylindrical body 110. The left panel of FIG. 7 depicts a baseline state at time zero, where a laboratory animal 200 is positioned inside the tubular handling tool 100 and has not yet begun chewing through the fixed cap 120. The fixed cap 120 is visible at the top of the tubular handling tool 100, with the starter hole 122 intact. The tubular handling tool 100 is supported by a stand structure that maintains the cylindrical body 110 in an upright orientation with the fixed cap 120 accessible for observation.

With continued reference to FIG. 7, the right panel depicts the tubular handling tool 100 at a time approximately 60 minutes after the baseline state. The laboratory animal 200 inside the tubular handling tool 100 has chewed through the fixed cap 120, creating an escape hole 124 substantially larger than the original starter hole 122. The escape hole 124 displays a somewhat symmetrical circular pattern, contiguous with the now-obliterated starter hole 122, indicating that the mouse chewed in a relatively uniform manner around the circumference of the opening. The comparison between the baseline state and the post-chewing state illustrates how the escape hole 124 evolves over time as the laboratory animal 200 enlarges the opening to effect escape from the tubular handling tool 100.

The method for assessing physiological characteristics of a laboratory animal may further comprise a step of treating the fixed cap 120 with an agent configured to affect a speed of chewing by the laboratory animal. The penetrable material of the fixed cap 120, such as kraft cardstock, may be treated with various agents that either accelerate or decelerate the chewing activity of the laboratory animal inside the tubular handling tool 100. The treatment of the fixed cap 120 with such agents may be performed prior to adhering the fixed cap 120 to the distal end 114 of the cylindrical body 110, or the treatment may be applied to the fixed cap 120 after assembly of the tubular handling tool 100.

The agent may be selected from the group consisting of a sugar-based sweetener configured to increase the speed of chewing and capsaicin configured to decrease the speed of chewing. A sugar-based sweetener, such as a sugar-based coating or sugar incorporated into the material of the fixed cap 120, may make the penetrable material more palatable to the laboratory animal 200, encouraging more vigorous and sustained chewing activity that results in faster formation of the escape hole 124. Capsaicin applied to the fixed cap 120 may create an aversive taste sensation that discourages chewing activity, resulting in slower formation of the escape hole 124 as the laboratory animal 200 hesitates or reduces chewing intensity in response to the noxious stimulus.

The escape hole pattern may indicate contentment when sweet-flavored material is used, as evidenced by a fast escape speed and a large escape hole. A laboratory animal 200, presented with a fixed cap 120 comprising sugar-sweetened material or treated with a sugar-based coating, may exhibit increased motivation to chew through the material due to the pleasant taste associated with chewing. The contentment associated with the sweet flavor may result in sustained chewing behavior that produces a large escape hole 124 in a relatively short period. The combination of a fast escape speed and a large escape hole size when sweet-flavored material is used may serve as an indicator of a positive affective state or contentment in the laboratory animal 200.

The escape hole pattern may indicate stress when noxious material is used, as evidenced by a slow escape speed and a small escape hole. A laboratory animal 200, presented with a fixed cap 120 treated with capsaicin or another noxious agent, may exhibit reduced motivation to chew through the material due to the unpleasant taste sensation associated with chewing. The stress associated with the noxious flavor may result in hesitant or intermittent chewing behavior that produces a small escape hole 124 over a prolonged period. The combination of a slow escape speed and a small escape hole size when noxious material is used may serve as an indicator of a negative affective state or stress in the laboratory animal 200. The laboratory animal 200 may chew only the minimum amount required to create an opening sufficient for escape, minimizing contact with the noxious material while still achieving exit from the tubular handling tool 100.

The method for assessing physiological characteristics of a laboratory animal may further comprise a step of recording the escape hole 124 with a camera 140 positioned within view of the fixed cap 120. The camera 140 may be positioned within view of the fixed cap 120 to monitor and record the progress of the laboratory animal 200 chewing or gnawing through the fixed cap 120. The camera 140 may be oriented to capture images or video of the fixed cap 120 throughout the duration of the escape attempt, providing a visual record of the evolving escape hole as the laboratory animal enlarges the opening by chewing or gnawing the penetrable material.

The camera 140 may be configured to capture images at regular intervals, such as every second or every minute, to document the progression of the escape hole over time. Alternatively, the camera 140 may be configured to capture continuous video of the fixed cap 120, enabling frame-by-frame analysis of chewing activity and escape-hole formation. The camera 140 may be a digital camera, a webcam, or another image-capture device capable of recording visual information of the fixed cap 120 and the escape hole 124 created by the laboratory animal 200.

The method may further comprise a step of using image processing techniques to quantify at least one of a speed and an extent of gnawing when escape occurs. Image processing techniques may be applied to images or video captured by the camera 140 to extract quantitative measurements of escape hole 124 formation. The image processing techniques may include edge detection algorithms to identify the perimeter of the escape hole 124, area calculation algorithms to determine the size of the escape hole 124 at each time point, and shape analysis algorithms to characterize the symmetry or asymmetry of the escape hole pattern.

The speed of gnawing may be quantified by analyzing the change in the size of the escape hole 124 over time. Image processing techniques may calculate the area of the escape hole in successive images or video frames, and the rate of change in area may be computed to determine how quickly the laboratory animal 200 enlarges the opening. The speed of gnawing may be expressed as area per unit time (e.g., square millimeters per minute) or as a radial expansion rate (e.g., millimeters per minute).

The extent of gnawing may be quantified by analyzing the final size and shape of the escape hole 124 upon escape. Image processing techniques may calculate the total area of the escape hole 124, the maximum diameter of the escape hole 124, and the perimeter length of the escape hole 124. The extent of gnawing may also be characterized by comparing the escape hole 124 dimensions to the printed markings on the fixed cap 120, as described previously, with image processing techniques identifying which circles have been breached by the chewing activity.

A system for handling and monitoring laboratory animals may further comprise a camera 140 positioned within view of the fixed cap 120, the camera 140 configured to monitor and record progress of the laboratory animal 200 chewing or gnawing through the fixed cap 120. The camera 140 may be mounted on a stand, attached to a cage structure, or positioned on a laboratory bench at an angle that provides a clear view of the fixed cap 120. The camera 140 may be connected to a computer or recording device that stores the captured images or video for subsequent analysis.

The system may further comprise image processing means configured to quantify at least one of a speed and an extent of gnawing when escape occurs. The image processing means may comprise software executed on a computer or processor that receives images or video from the camera 140 and applies image processing algorithms to extract quantitative measurements. The image processing means may include machine learning algorithms trained to recognize the boundaries of escape hole 124, artificial intelligence systems configured to track the progression of escape hole 124 over time, and data analysis modules that compute speed and extent metrics from the processed images.

The image processing means may generate output data including time-stamped measurements of escape hole area, graphs showing escape hole size versus time, and summary statistics regarding the speed and extent of gnawing for each laboratory animal 200 assessed. The output data may be stored in a database for comparison across multiple laboratory animals 200 or across multiple assessment sessions for the same laboratory animal 200. The image processing means may also generate alerts or notifications when escape occurs, based on detection of the escape hole reaching a threshold size or based on detection of the laboratory animal exiting through the escape hole 124.

The method for assessing physiological characteristics of a laboratory animal may further comprise a step of detecting a temperature inside the tubular tool 100 with a temperature probe 150. The temperature probe 150 may be positioned to measure the ambient temperature within the enclosed space while the laboratory animal is contained inside. The temperature probe 150 may comprise a thermocouple, thermistor, or other temperature-sensing element capable of detecting temperature changes within the interior space 116.

When the laboratory animal is positioned inside the tubular tool 100, the temperature inside the tubular tool 100 registers above ambient temperature because of the heat generated by the laboratory animal 200 inside the small space. The body heat of the laboratory animal 200 radiates into the enclosed interior space 116, causing the temperature detected by the temperature probe 150 to rise above the ambient temperature of the surrounding environment. The magnitude of the temperature increase above ambient may depend on factors including the size of the laboratory animal 200, the duration the laboratory animal has been inside the tubular tool 100, and the degree of enclosure provided by the fixed cap 120 and any removable cap 130 attached to the proximal end 112.

A decrease in temperature toward ambient temperature indicates that the laboratory animal 200 has exited the tubular tool 100 through the escape hole 124. Once the laboratory animal 200 chews or gnaws through the fixed cap 120 to create an escape hole 124 of sufficient size and exits through the escape hole 124, the heat source provided by the body of the laboratory animal 200 is removed from the interior space 116. The temperature inside the tubular tool 100 then decreases as the interior space 116 equilibrates with the surrounding environment, and the temperature detected by the temperature probe 150 returns to ambient or near-ambient levels.

The temperature probe 150 thereby provides a means for determining the time required for the laboratory animal 200 to escape the tubular tool 100. By monitoring the temperature signal from the temperature probe 150 over time, an operator or automated system may detect the transition from elevated temperature to ambient temperature, with the time of this transition corresponding to the time at which the laboratory animal 200 exited through the escape hole 124. The temperature-based detection of escape may complement visual observation or camera-based monitoring of the escape hole formation, providing an independent confirmation of when the laboratory animal 200 has successfully escaped from the tubular tool 100.

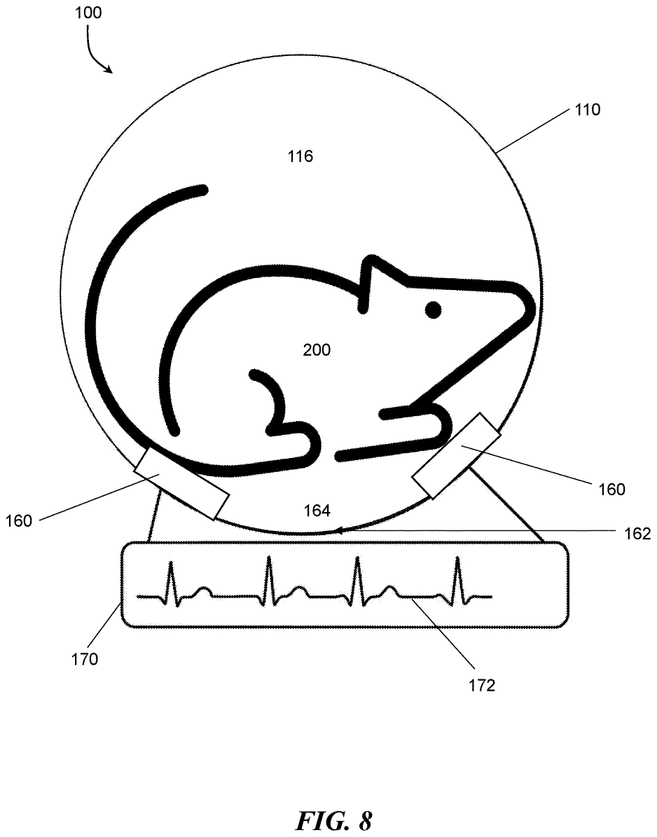

Referring to FIG. 8, a system for handling and monitoring laboratory animals 200 comprises a tubular tool 100 configured with two conductive strips 160 disposed along an interior floor 162 of the cylindrical body 110. As described previously, the tubular tool 100 comprises a cylindrical body 110 having an interior space 116 configured to accommodate a laboratory animal 200, and a fixed cap 120 permanently adhered to a distal end 114 of the cylindrical body 110. The fixed cap 120 is made of a material penetrable by the laboratory animal, such as kraft cardstock, as described previously. The fixed cap 120 may include a starter hole 122 configured to provide a starting point for the laboratory animal to chew or gnaw, creating an escape opening through the fixed cap 120.

With continued reference to FIG. 8, the two conductive strips 160 are separated by a neutral floor region 164. The neutral floor region 164 extends along the length of the interior floor 162 between the two conductive strips 160, providing electrical isolation between the conductive strips 160. The two conductive strips 160 may be adhered along the length of the interior floor 162 of the cylindrical body 110, extending from a region proximate to the proximal end 112 toward the distal end 114 of the cylindrical body 110. The conductive strips 160 may be made of conductive material such as metal foil, conductive tape, or conductive ink applied to the interior floor 162.

As further shown in FIG. 8, the system comprises ECG recording instrumentation 170 electrically connected to the two conductive strips 160. One conductive strip 160 is electrically connected to one polarity of the ECG recording instrumentation 170, and the other conductive strip 160 is electrically connected to the opposite polarity of the ECG recording instrumentation 170. Electrical leads may extend from each conductive strip 160 to corresponding input terminals of the ECG recording instrumentation 170, establishing the electrical connection between the conductive strips 160 and the ECG recording instrumentation 170.

The ECG recording instrumentation 170 is configured to detect and record electrocardiogram signals from the laboratory animal 200 standing inside the tubular tool 100 with paws contacting the two conductive strips 160. When the laboratory animal stands within the interior space 116 of the tubular tool 100, the animal's paws contact the interior floor 162. With the two conductive strips 160 positioned along the interior floor 162 and separated by the neutral floor region 164, the laboratory animal standing with paws on opposite sides of the neutral floor region 164 completes an electrical circuit between the two conductive strips 160. The electrical potential difference generated by the cardiac activity of the laboratory animal is conducted through the animal's body and detected by the two conductive strips 160, with the ECG recording instrumentation 170 amplifying and recording the electrocardiogram signals.

With continued reference to FIG. 8, the ECG recording instrumentation 170 may display an ECG waveform output 172 representing the cardiac electrical activity detected from the laboratory animal 200. The ECG waveform output 172 may comprise repeating cardiac signal traces with characteristic peaks and valleys representative of heart electrical activity, including P waves, QRS complexes, and T waves corresponding to atrial depolarization, ventricular depolarization, and ventricular repolarization, respectively. The ECG recording instrumentation 170 may record the ECG waveform output 172 for subsequent analysis, allowing assessment of heart rate, heart rate variability, and cardiac rhythm in the laboratory animal 200.

The ECG signals and heart rate are passively detectable and recordable from the laboratory animal 200 standing inside the tubular tool 100 without requiring attachment of electrodes to the body of the laboratory animal 200. The passive detection of ECG signals through the conductive strips 160 on the interior floor 162 of the tubular tool 100 reduces handling stress associated with electrode attachment procedures and permits ECG recording during routine handling procedures when the laboratory animal 200 is retrieved using the tubular tool 100.

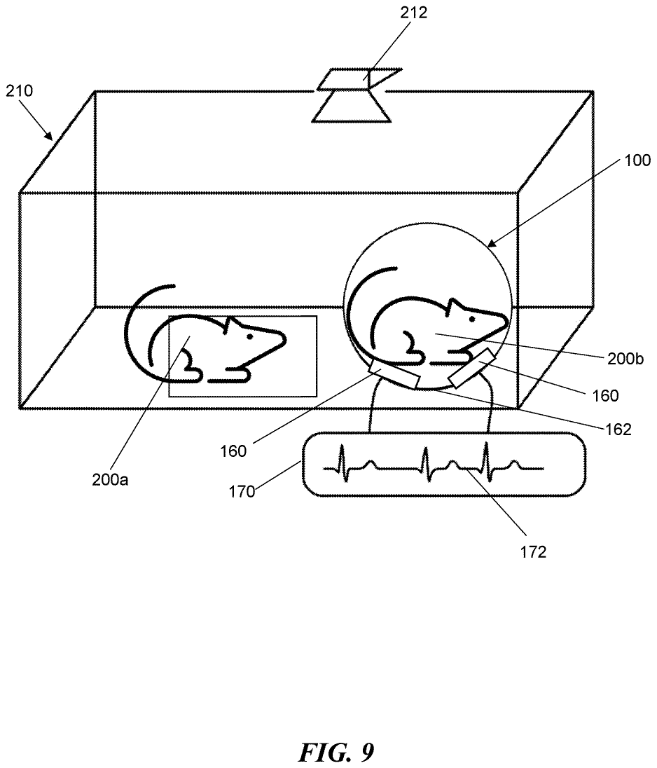

Referring to FIG. 9, the system for handling and monitoring laboratory animals may be configured for home cage monitoring with the tubular tool 100 positioned inside an animal enclosure 210. The animal enclosure 210 may comprise a transparent rectangular cage structure that serves as the home cage for one or more laboratory animals 200. The tubular tool 100 is configured to be positioned inside an animal cage, such as the animal enclosure 210, allowing it to remain within the living environment of the laboratory animals 200 for extended periods.

With continued reference to FIG. 9, the tubular tool 100 may be oriented horizontally within the animal enclosure 210, with the proximal end 112 and the distal end 114 accessible to laboratory animals residing within the animal enclosure 210. The fixed cap 120 at the distal end 114 may include a circular viewing window or opening through which an animal inside the tubular tool 100 may be observed. A camera or monitoring device 212 may be positioned above the animal enclosure 210 to observe activity within the cage, including entry and exit of laboratory animals from the tubular tool 100.

As further shown in FIG. 9, the animal enclosure 210 may contain multiple laboratory animals 200, with a first laboratory animal 200a freely moving on the cage floor and a second laboratory animal 200b positioned inside the tubular tool 100. The tubular tool 100 provides an enclosed space that laboratory animals may voluntarily enter, as small rodents naturally prefer enclosed environments that offer shelter and security. With either one end or both ends of the tubular tool 100 left open, or made open by the animal itself through chewing the fixed cap 120, the laboratory animal may choose to enter the tubular tool 100 at will.

The ECG recording instrumentation 170 is electrically connected to the two conductive strips 160 disposed along the interior floor 162 of the tubular tool 100, as described previously. Electrical leads may extend from the conductive strips 160 through the bottom of the animal enclosure 210 to the ECG recording instrumentation 170 positioned external to the cage. The ECG recording instrumentation 170 is configured to detect and record electrocardiogram signals when the laboratory animal voluntarily enters the tubular tool 100. When a laboratory animal 200 enters the tubular tool 100 and stands with paws contacting the two conductive strips 160, the ECG recording instrumentation 170 detects the cardiac electrical activity and records the electrocardiogram signals.

Arranging the tubular tool 100, as configured, inside the animal enclosure 210 enables recording of the ECG within the cage without requiring retrieval of the laboratory animal from its home cage environment. The ECG may be detected when the laboratory animal 200 enters the tubular tool 100, enabling passive monitoring of cardiac function during voluntary behavior rather than during handling procedures that may induce stress responses. The home cage monitoring configuration permits continuous or periodic cardiac monitoring without requiring removal of the laboratory animals 200 from their housing, thereby reducing handling stress and enabling more naturalistic physiological measurements representative of the resting or baseline cardiac state of the laboratory animal 200.

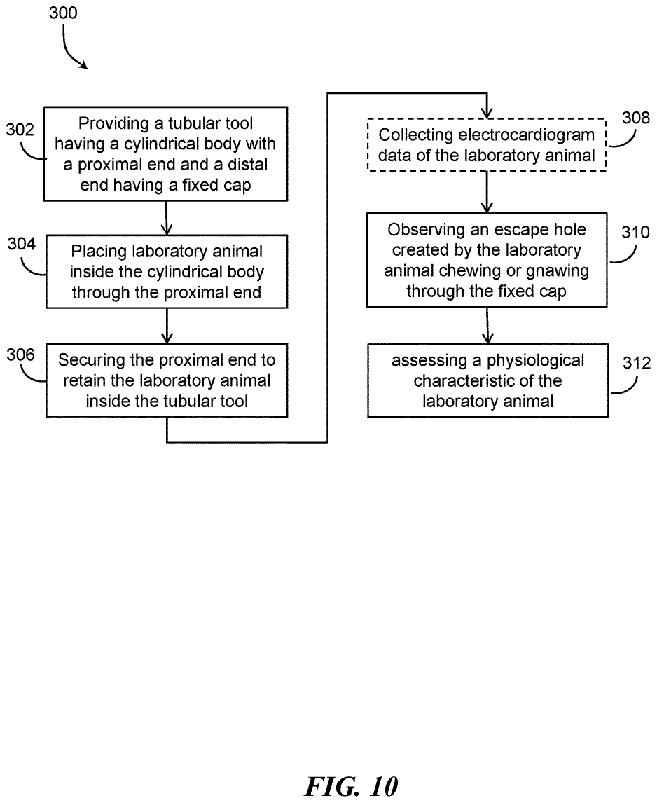

The tubular handling tool 100 and monitoring system operate in an integrated manner to facilitate humane handling of laboratory animals 200 while simultaneously collecting physiological data through multiple measurement modalities. An example of such a method 300 for assessing physiological characteristics of a laboratory animal 200 is presented in FIG. 10.

The first step of the method 300 of FIG. 10 is providing a tubular tool 100 having a cylindrical body 110 with a proximal end 112 and a distal end 114, wherein the distal end 114 includes a fixed cap 120 made of a penetrable material as set forth above (Step 302).

The next step is placing the laboratory animal 200 inside the cylindrical body 110 through the proximal end 112 (Step 304). Here, an operator retrieves a laboratory animal 200 from a cage or enclosure 210 using the tubular handling tool 100 as described in relation to FIG. 2. The operator grasps the cylindrical body of the tubular handling tool 100 and directs the open proximal end 112 toward the laboratory animal 200, scooping the laboratory animal 200 into the interior space 116 of the cylindrical body. The fixed cap 120 at the distal end 114 prevents the laboratory animal 200 from exiting through the distal end 114 during retrieval, directing the laboratory animal 200 to remain within the interior space 116 as the operator lifts the tubular handling tool 100 from the cage or enclosure 210.

After placing the laboratory animal 200 inside the cylindrical body 110 through the proximal end 112 (Step 304), the next step is securing the proximal end 112 to retain the laboratory animal 200 inside the tubular tool 100 (Step 306). Here, once the laboratory animal 200 has entered the interior space through the proximal end 112, the operator may attach a removable cap 130 to the proximal end 112 to secure the laboratory animal 200 inside the tubular handling tool 100. The removable cap 130 engages the proximal end 112 of the cylindrical body 110 via a retention mechanism requiring human force to remove, preventing the laboratory animal 200 from dislodging the removable cap 130 by pushing from within the interior space 116. With both ends of the tubular handling tool 100 secured, the laboratory animal 200 is retained inside the enclosed space 116 during transport to a procedure station or during assessment procedures.

In embodiments in which the tubular tool 100 is provided with ECG recording instrumentation 170, the electrocardiogram data of the laboratory animal can be collected (Step 308). Here, the conductive strips 160 disposed along the interior floor 162 of the cylindrical body 110 begin to detect electrocardiogram signals when the laboratory animal stands 200 inside the tubular handling tool 100, with its paws contacting the conductive strips 160. The ECG recording instrumentation 170 electrically connected to the conductive strips 160 amplifies and records the cardiac electrical activity detected through the paws of the laboratory animal 200 as described previously in reference to FIG. 8. The ECG recording may commence immediately upon the laboratory animal 200 entering the tubular handling tool 100 and may continue throughout the duration of the handling procedure, providing a continuous record of heart rate and cardiac rhythm during the retrieval and transport process.

The next step of the method 300 is observing an escape hole 124 created by the laboratory animal 200 chewing or gnawing through the fixed cap 120 (Step 310) followed by assessing a physiological characteristic of the laboratory animal 200 (Step 312) as described previously in relation to FIG. 4 through FIG. 7.

The assessment of chewing behavior and escape hole 124 formation (Step 310 and Step 312) may proceed concurrently with ECG recording (Step 308). The laboratory animal 200 inside the tubular handling tool 100 may orient toward the fixed cap 120 at the distal end 114, attracted by air and light entering through the starter hole 122 disposed in the fixed cap 120. The laboratory animal 200 may begin chewing or gnawing at the edges of the starter hole 122, using teeth to remove material from the penetrable fixed cap 120 and enlarge the opening. The chewing activity and the formation of the escape hole 124 may be observed using multiple measurement modalities operating simultaneously.

Visual observation by an operator provides a direct assessment of chewing behavior and the formation of the escape hole 124. The operator may observe the fixed cap 120 throughout the duration of the escape attempt, noting the time at which chewing commences, the rate at which the escape hole enlarges, and the pattern of the evolving escape hole. The printed markings 126 on the fixed cap 120 provide reference gauges that aid the operator in quantifying the extent of chewing by comparing the perimeter of the escape hole 124 to the circular markings.

In certain embodiments, a camera 140 positioned within view of the fixed cap 120 may record images or video of the formation of the escape hole 124, providing a visual record for subsequent analysis. The camera 140 may capture the progression of the escape hole 124 from the initial starter hole to the final opening through which the laboratory animal 200 exits. Image processing techniques applied to the captured images or video may extract quantitative measurements, including the area of the escape hole 124 at each time point, the rate of change in escape hole area over time, and the symmetry or asymmetry of the escape hole 124 pattern. The image processing means may generate output data including time-stamped measurements and summary statistics regarding the speed and extent of gnawing.

In some embodiments, a temperature probe 150 may detect the ambient temperature within the enclosed space of the tubular handling tool 100. The temperature inside the tubular handling tool exceeds ambient due to body heat generated by the laboratory animal in the confined space. The temperature probe 150 provides a continuous temperature signal that may be monitored throughout the assessment procedure. When the laboratory animal 200 chews through the fixed cap and exits through the escape hole 124, the temperature inside the tubular handling tool 100 decreases as the interior space 116 equilibrates with the surrounding environment. The transition from elevated temperature to ambient temperature provides an independent confirmation of when the laboratory animal 200 has successfully escaped from the tubular handling tool 100.

The multiple measurement modalities work together to provide a comprehensive physiological assessment during routine handling procedures. The ECG recording provides cardiac data, including heart rate, heart rate variability, and cardiac rhythm that may indicate cardiovascular health, stress responses, or the effects of administered drugs on cardiac function. Visual observation, camera recording, and image processing provide behavioral and motor function data, including chewing speed, escape hole size, and escape hole pattern, which may indicate neck mobility, shoulder function, jaw strength, oral health, neurological status, anxiety level, aggression level, and pain laterality. Temperature detection provides timing data that confirms when escape occurs and may complement visual and image-based measurements of escape time.

The integration of these measurement modalities within a single handling tool 100 allows the collection of diverse physiological data during a single handling event. An operator retrieving a laboratory animal 200 for a scheduled procedure may simultaneously record ECG signals during transport, observe chewing behavior and escape-hole formation during an assessment period, and detect the time of escape via temperature monitoring. The physiological data collected through the multiple measurement modalities may be correlated to provide a comprehensive assessment of the health and behavioral status of the laboratory animal.

The system may also operate in a home cage monitoring configuration where the tubular handling tool 100 is positioned inside an animal enclosure 210 for extended periods. Laboratory animals 200 residing within the enclosure 210 may voluntarily enter the tubular handling tool 100, attracted by the enclosed space that approximates a natural preference for shelter. When a laboratory animal 200 enters the tubular handling tool 100 and stands with paws contacting the conductive strips 160, the ECG recording instrumentation 170 detects and records electrocardiogram signals. The voluntary entry of the laboratory animal 200 into the tubular handling tool 100 enables passive cardiac monitoring without requiring retrieval of the laboratory animal 200 from the home cage environment.

In the home cage monitoring configuration, the fixed cap 120 may be left intact, with the starter hole 122 providing air and light entry, or it may be opened by the laboratory animal 200 through chewing activity. When the fixed cap 120 includes a starter hole 122, a laboratory animal 200 inside the tubular handling tool 100 may choose to chew through the fixed cap 120 to create an escape opening, with the chewing behavior and escape hole 124 formation observable through a camera 212 positioned above the enclosure. The home cage monitoring configuration permits assessment of chewing behavior during voluntary entry into the tubular handling tool, providing behavioral data representative of naturalistic activity rather than responses to handling procedures.

The tubular handling tool 100 thus provides a dual-function apparatus that facilitates both humane handling of laboratory animals and collection of physiological data through multiple measurement modalities. The interaction of the structural elements of the tubular handling tool 100, including the cylindrical body 110, fixed cap 120, starter hole 122, removable cap 130, and conductive strips 160, with the monitoring components, including the ECG recording instrumentation 170, camera 140, image processing means, and temperature probe 150, enables comprehensive physiological assessment during routine handling procedures or during voluntary entry in a home cage monitoring configuration.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extent or degree of an action, characteristic, property, state, structure, item, or result as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may, in some instances, depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way that enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A tubular handling tool for laboratory animals, comprising:
a cylindrical body having a proximal end and a distal end, the cylindrical body defining an interior space configured to accommodate a small laboratory animal;
a fixed cap permanently adhered to the distal end of the cylindrical body, the fixed cap being made of a material penetrable by chewing or gnawing by the laboratory animal inside the interior space; and
a starter hole disposed in the fixed cap, the starter hole configured to provide a starting point from which the laboratory animal may chew or gnaw to create an escape opening through the fixed cap.

2. The tubular handling tool of claim 1, wherein the fixed cap is made of kraft cardstock.

3. The tubular handling tool of claim 1, wherein the fixed cap is permanently adhered to the distal end of the cylindrical body with a non-toxic adhesive.

4. The tubular handling tool of claim 3, wherein the non-toxic adhesive is super glue, which becomes non-toxic when dried.

5. The tubular handling tool of claim 1, wherein the starter hole has a diameter in a range from 1/32 inch to ⅛ inch.

6. The tubular handling tool of claim 1, wherein the starter hole is configured to permit air and light to enter the interior space.

7. The tubular handling tool of claim 1, further comprising a removable cap configured to be attached to the proximal end of the cylindrical body to retain the laboratory animal inside the interior space.

8. The tubular handling tool of claim 7, wherein the removable cap requires human force to remove and is configured such that the laboratory animal inside the interior space does not have sufficient strength to remove the removable cap from inside.

9. The tubular handling tool of claim 7, wherein the removable cap is made from a hard and smooth material that cannot be penetrated by teeth or claws of the laboratory animal inside.

10. The tubular handling tool of claim 1, wherein the cylindrical body has a diameter in a range from 1.5 inches to 2.5 inches, a wall thickness in a range from 0.125 inches to 0.25 inches, and a length in a range from 3 inches to 5 inches.

11. The tubular handling tool of claim 1, wherein the fixed cap includes printed markings configured to aid in quantifying a rate and extent of chewing or gnawing by the laboratory animal.

12. A method for assessing physiological characteristics of a laboratory animal, comprising:
providing a tubular tool having a cylindrical body with a proximal end and a distal end, wherein the distal end includes a fixed cap made of a penetrable material;
placing the laboratory animal inside the cylindrical body through the proximal end;
securing the proximal end to retain the laboratory animal inside the tubular tool;
observing an escape hole created by the laboratory animal chewing or gnawing through the fixed cap; and
assessing a physiological characteristic of the laboratory animal based on at least one of a size, a shape, a rate of formation, and a pattern of the escape hole.

13. The method of claim 12, wherein the physiological characteristic is selected from the group consisting of neck mobility, shoulder function, jaw strength, oral health, neurological status, anxiety level, aggression level, and pain laterality.

14. The method of claim 12, further comprising a step of recording the escape hole with a camera positioned within view of the fixed cap.

15. The method of claim 14, further comprising a step of using image processing techniques to quantify at least one of a speed and an extent of gnawing when escape occurs.

16. The method of claim 12, wherein the fixed cap includes printed markings, and the method further comprises a step of using the printed markings to quantify a rate and an extent of chewing or gnawing by the laboratory animal.

17. The method of claim 12, further comprising a step of treating the fixed cap with an agent configured to affect a speed of chewing by the laboratory animal.

18. The method of claim 17, wherein the agent is selected from the group consisting of a sugar-based sweetener configured to increase the speed of chewing and capsaicin configured to decrease the speed of chewing.

19. The method of claim 12, further comprising a step of diagnosing a lateralized condition based on an asymmetry of a pattern of the escape hole, wherein the asymmetry indicates pain or injury on a side of the laboratory animal opposite to a direction of the asymmetry.

20. The method of claim 12, further comprising a step of detecting a temperature inside the tubular tool with a temperature probe, wherein a decrease in temperature toward ambient temperature indicates that the laboratory animal has exited the tubular tool through the escape hole.

21. A system for handling and monitoring laboratory animals, comprising:
a tubular tool comprising:
a cylindrical body having an interior space configured to accommodate a laboratory animal;
a fixed cap permanently adhered to a distal end of the cylindrical body, the fixed cap being made of a material penetrable by chewing or gnawing by the laboratory animal; and
two conductive strips disposed along an interior floor of the cylindrical body, the two conductive strips being separated by a neutral floor region; and
ECG recording instrumentation electrically connected to the two conductive strips, wherein the ECG recording instrumentation is configured to detect and record electrocardiogram signals from the laboratory animal standing inside the tubular tool with paws contacting the two conductive strips.

22. The system of claim 21, wherein the fixed cap includes a starter hole configured to provide a starting point from which the laboratory animal may chew or gnaw to create an escape opening through the fixed cap.

23. The system of claim 21, wherein the tubular tool is configured to be positioned inside an animal cage, and wherein the ECG recording instrumentation is configured to detect and record electrocardiogram signals when the laboratory animal voluntarily enters the tubular tool.

24. The system of claim 21, further comprising a camera positioned within view of the fixed cap, the camera configured to monitor and record progress of the laboratory animal chewing or gnawing through the fixed cap.

25. The system of claim 24, further comprising image processing means configured to quantify at least one of a speed and an extent of gnawing when escape occurs.
